(19) United States
(12) Patent Application Publication
(10) Pub. No.: US 2011/0278952 A1
(43) Pub. Date: Nov. 17, 2011

(54) CAPACITIVE DC-DC CONVERTER

(75) Inventors: Klaus Reimann, Eindhoven (NL); Willem Frederik Adrianus Besling, Eindhoven (NL); Hendrik Johannes Bergveld, Eindhoven (NL); Pavel Novoselov, Eindhoven (NL)

(73) Assignee: NXP B.V., Eindhoven (NL)

(21) Appl. No.: 13/128,465

(22) PCT Filed: Oct. 28, 2009
(86) PCT No.: PCT/IB2009/054773

§ 371 Date: Aug. 1, 2011

(30) Foreign Application Priority Data
Nov. 10, 2008 (EP) 08105754.9

(51) Int. Cl. H02M 3/06

(52) U.S. Cl. 307/109

(57) ABSTRACT

A charge-pump capacitive DC-DC converter (200) is disclosed, which includes a reconfigurable charge-pump capacitor array. The DC-DC converter is configured to provide a continuously variable ratio between its input voltage (Vᵢₙ) and its output voltage (Vₒᵤₜ), by means of at least one of the at least one charge-pump capacitors (C21, C22) forming the reconfigurable array being a variable capacitor. In the embodiments, the one or more variable capacitors (C21, C22) may be a ferroelectric capacitor, an anti-ferroelectric capacitor, or other ferrioc capacitor. The DC-DC converter (200) may provide a bias circuit to the capacitor or capacitors, and may further provide a control loop (220, 230). Alternatively, the capacitor may provide a degree of self-control.

### FIELD OF THE INVENTION

This invention relates to DC-DC converters. It is particularly concerned with charge-pump capacitive DC-DC converters, and methods of controlling such DC-DC converters.

### BACKGROUND OF THE INVENTION

A simple method of supplying a load with a voltage which is lower than the available supply voltage is by means of a linear regulator. A linear regulator basically is a controlled resistance in series with the load. However, as the load voltage decreases relative to the supply voltage, the voltage required to be dropped across the controlled resistance increases. The power dissipated in the controlled resistance increases, and the overall efficiency of the regulator decreases. Thus although able to accommodate widely separated supply and load voltages, a linear regulator is then inefficient.

An alternative solution, which is being used increasingly, is the switched-mode power supply or DC-DC converter. Instead of a resistive component, a reactive component is used. Conceptually, such a converter is based on imaginary (reactive) power, as the current and voltage are in quadrature, rather than real (resistive) power, and thereby real power dissipation can be reduced. Reactive converters require either an inductive or a capacitive element as the reactive element.

Although in theory and ignoring resistive and switch losses, an inductive converter could be 100% efficient, a capacitive converter will always be less than 100% efficient, due to the ripple losses resulting from the energy ½CΔV² lost each time the capacitor is charged over an excursion ΔV

Especially for larger voltage differences between input and output it is well known that a switched-mode converter can easily outperform a linear regulator in terms of efficiency: as opposed to a linear regulator where energy is passed on continuously from input to output and by nature energy is lost in the ‘pass transistor’, in a switched mode converter energy is temporarily stored in an energy buffer (inductor and/or capacitor) and then released to the load. The more ideal the energy storage elements are, the higher the efficiency can become. In practice, the efficiency can ‘approach’ values above 90% even for larger voltage differences between input and output voltage.

For all switched-mode converters the needed sizes of the energy buffers go down when the switching frequency goes up. This is beneficial for integration purposes. However, in practice it is hard to miniaturize inductors and keeping the Q factor at an acceptable level. In contrast, by achieving very high capacitance density, integration of capacitors onto silicon substrate or into a package becomes feasible.

In a capacitive converter, the charge is loaded on one or more “pump” capacitors in a first part of the switching cycle by connecting the capacitors to the source or supply in an appropriate series/parallel configuration. The capacitors are then discharged to the load during a second part of the switching cycle. A buffer capacitor is generally connected in parallel to the load to decrease the output voltage ripple and supply energy to the load when the pump capacitors are charged from the input. Changing the series/parallel configurations between the capacitors in the first and second parts of the switching cycle can change the output voltage in discrete steps. Capacitive converters achieve the highest efficiency for a load-to-source voltage ratio close to these steps. A common technique for continuous control of the output voltage or current is to add a linear regulator between the switched power supply and the load. The switched power supply might adapt in discrete steps to the load and the linear regulator can continuously regulate in between these steps.

United States patent publication U.S. Pat. No. 5,841,648 discloses such a capacitive converter, wherein a linear regulator is connected in series with the pump capacitor. Alternatively, a variable impedance may be added in series to the pump capacitor which has a fixed capacitance, as is disclosed in patent application WO2004/064234.

Techniques have been proposed for a continuously regulating a converter. For instance, it has been proposed in United States patent publication US-B-6538907 to turn the charge pump on or off once a threshold on the buffer capacitor is reached. Alternatively, it has the proposed that the switching frequency be changed; however, this can result in unpredictable magnetic interference with communication lines. A change of the duty cycle prevents frequency changes, but might result in decreased efficiency and strongly enhanced higher harmonics. Thus these techniques are unsatisfactory in that they are associated with an increased risk of electromagnetic interference (emi).

To date, there has been no satisfactory solution, which effectively combines the advantages of capacitive converters with continuously variable control of the ratio between the input and output, or supply and load, voltages.

### SUMMARY OF THE INVENTION

It is an object of the present invention to provide an improved capacitive converter, which allows for a high-efficiency voltage conversion, and overweight of the need for a linear regulator.

According to the invention there is provided a capacitive DC-DC converter comprising an input for receiving current at an input voltage, an output for supplying current at an output voltage, a charge-pump capacitor array which is reconfigurable within the DC-DC converter and comprises at least one charge-pump capacitor, and a plurality of switches for reconfiguring the reconfigurable charge-pump capacitor array, characterized in that the capacitive DC-DC converter is configured to provide a continuously variable ratio between the input voltage and the output voltage of means of at least one of the at least one charge-pump capacitors being a variable capacitor.

By such a device, the need for a linear regulator which would add extra size and cost to a voltage converter is avoided. Moreover, by omitting a linear regulator, the control is simplified, in that there is no requirement to match converter and the regulator control of avoiding instabilities or interference. At the same time, the problems of possible emi associated with changing switching frequency or duty cycle of prior art capacitive converters are avoided, since a continuous variation of the output voltage is enabled over at least some part of the operating range of the device, without any requirement to change switching frequency or duty cycle. Beneficially, no inductors are required.

Preferably, the variable capacitor is adapted such that its capacitance decreases as a voltage across it increases, over a predetermined voltage range. By providing a feedback mechanism, this feature allows the variable capacitor to provide a degree of self-regulation or self-control to the DC-DC converter.

In a preferred embodiment, the capacitive DC-DC converter further comprises a bias circuit for biasing the variable capacitor. More preferably, the bias circuit comprises a further capacitor in series with the variable capacitor, the node therebetween being connected to a bias voltage by means of a bias resistor. The further capacitor may be a fixed capacitor or a further variable capacitor. Such a bias circuit may allow a fast response to changing loads without deteriorating the efficiency at stable loads. Of course, the resistor need not be a separate component, but may comprise the source-drain resistance of the control transistor of the switch.

In advantageous embodiments, the capacitive DC-DC converter further comprises a control loop for controlling the variable capacitor. The control loops may include sensing means for sensing the output voltage and control means for controlling the biasing circuit. Such embodiments are compatible with a wide variety of variable capacitors. Alternatively, but without limitation, the variable capacitor on the DC-DC converter may be configured such that a change in the output voltage or the input voltage would change the capacitance directly. In such embodiments there is no requirement for additional control circuitry.

The capacitive DC-DC converter may be configured such that the output voltage is variable independent of variation in the input voltage; alternatively, but without limitation, and the capacitive DC-DC converter may be configured such that the output voltage is constant independent of variation in the input voltage.

In embodiments of the invention the charge-pump capacitor array may comprise a plurality of charge-pump capacitors. This provides for a greater degree of design freedom, and allows for the use of smaller variable capacitors, which are thus easier to design onto a single substrate.

Beneficially, a buffer capacitor may be connected across the output. Such a buffer or smoothing capacitor can act to reduce the ripple on the output voltage, and thus ensure that the capacitive converter is able to provide a particularly smoothly regulated voltage output.

The at least one charge-pump capacitor and the plurality of switches may be provided on the same substrate. In such embodiments, the at least one charge-pump capacitor may be a semiconductor varactor, since these types of variable capacitor are particularly suited to integrated with standard CMOS or BiCMOS processes.

In other alternative embodiments, without limitation, the at least one charge-pump capacitor and the plurality of switches may be provided on separate substrates and integrated into the same package. In such embodiments, it is particularly convenient that the at least one charge-pump capacitor may be a ferroic capacitor.

According to another aspect of the present invention, there is provided a method of controlling a capacitive DC-DC converter comprising an input for receiving an input voltage, an output for supplying an output voltage, a reconfigurable charge-pump capacitor array comprising at least one charge-pump variable capacitor and a plurality of switches for reconfiguring the reconfigurable charge-pump capacitor array, the method comprising varying at least one of the at least one charge-pump variable capacitor such that the output voltage is controlled independent of variation in the input voltage.

The method preferably includes the step of biasing at least one of the at least one variable capacitor.

The method may further include the step of sensing the output voltage and biasing at least one of the at least one variable capacitor in dependence on the output voltage.

The step of biasing at least one of the at least one variable capacitor further may beneficially involve regulating a maximum input current drawn by the capacitive DC-DC converter. The method may thus provide for an enhanced degree of regulation protection, without the requirement for additional circuitry and thus at little or no additional cost or design overhead.

The capacitive DC-DC converter may operate according to a pump cycle such that the at least one of the at least one variable capacitor is biased synchronously with the pump cycle. Thus a rapid response to transient voltages may be assured.

These and other aspects of the invention will be apparent from, and elucidated with reference to, the embodiments described hereinafter.

### BRIEF DESCRIPTION OF DRAWINGS

Embodiments of the invention will be described, by way of example only, with reference to the drawings, in which

FIG. 1 is a schematic circuit diagram of a capacitive DC-DC converter according to the prior art;

FIG. 2 is a schematic circuit diagram of a capacitive DC-DC converter according to a first embodiment of the present invention;

FIG. 3 is a schematic circuit diagram of a capacitive DC-DC converter according to a further embodiment of the present invention;

FIG. 4(a)-(d) show the capacitance/voltage responses of a variety of variable capacitors;

FIG. 5 illustrates the self-regulation capabilities of a suitable variable capacitor;

FIG. 6 shows a biasing circuit for a variable capacitor;

FIG. 7 shows the control loop for a variable capacitor forming part of a DC-DC converter; and

FIGS. 8(a) and 8(b) show two implementations of a variable capacitor integrated into a package.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

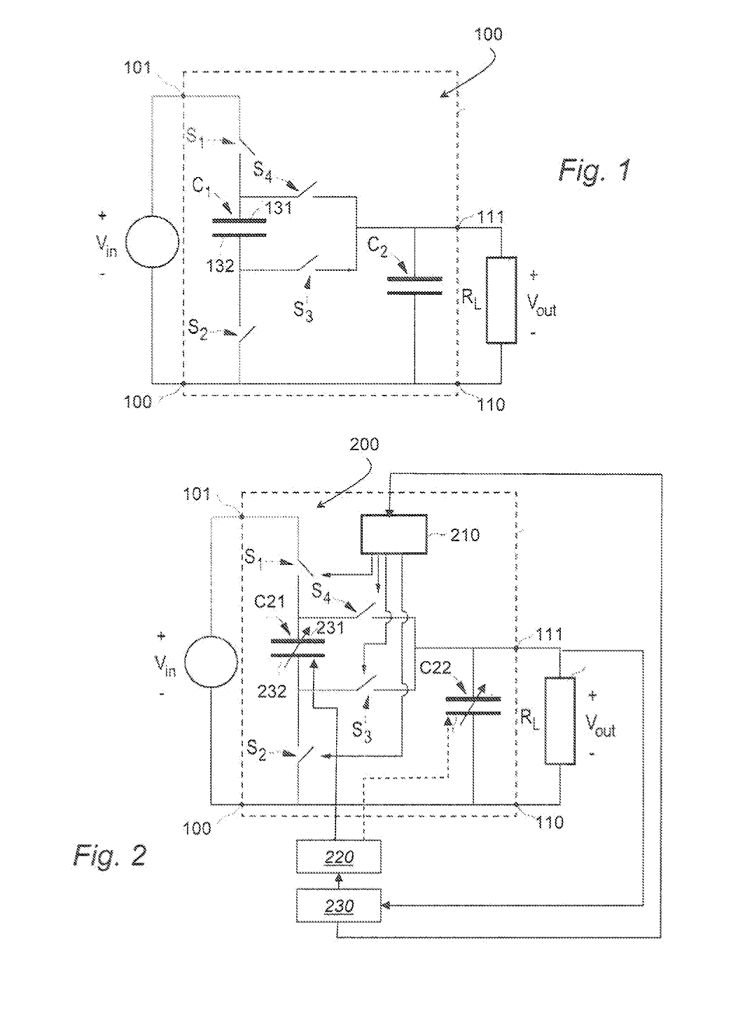

FIG. 1 shows a simplified schematic circuit diagram of a capacitive DC-DC converter according to the prior art. Voltage Vin is applied across input 100, 101, and load resistor R_{L}, draws current across a voltage of the output 111, 110. Switchably connected across input 100, 101, is a charge-pump capacitor C1. Switch 51 connects a first electrode 131 of capacitor C1 to the high side 101 of the input, and switch S2 connects the second electrode 132 of capacitor C1 to the low side 100 of the input. Switches S4 and S3 respectively connect the first electrode 131 and the second electrode 132 of charge pump capacitor C1 to the high side 111 of the voltage output. Second capacitor C2 is connected between the high and low sides 111 and 110 of the output.

In operation of the capacitive converter, in a first phase, a control unit (not shown) sets all odd-numbered switches are set to their conducting, i.e. closed, states. That is, by letting the switches S1 and S3 connect with the capacitors C1 and C2 in series, the series connection of C1 and C2 is charged to the input voltage of Vin. In a subsequent second operation phase of the DC-DC converter, the control unit opens the odd-numbered switches and closes the even-numbered switches S2 and S4. Thus, in the second operation phase, by opening all odd-numbered switches and closing all even-numbered switches the control unit provides a parallel connection of the capacitors C1 and C2 in parallel to the load resistor R_{L} at the output of the DC-DC converter. Consequently, the ratio of input and output voltages is 2:1. This is the case irrespective of whether or not the capacitors C1 and C2 are similar sized.

Considered from one perspective, the capacitors C1 and C2 both contribute to the charge-pump function. However, viewed from a second perspective, the capacitor C2 acts as a buffer capacitor or smoothing capacitor, since it is connected directly across the output load. Thus, when viewed from the second perspective, the circuit diagram of FIG. 1 may be considered to be a charge-pump capacitive converter having a single charge-pump capacitor.

FIG. 2 shows the DC-DC capacitive converter according to a first embodiment of the invention. The converter is similar to that depicted in FIG. 1, and corresponding components are thus referenced by corresponding reference numerals. In this converter, however, the charge-pump capacitor C1 is replaced by a variable charge-pump capacitor C21, having top and bottom electrodes to 231 and 232 respectively. Similarly, capacitor C2 is replaced by the variable capacitor C22. The control unit for controlling switches S1 through S4 is shown at 210; its operation is similar to that described above with reference to FIG. 1. However, the control unit 210 differs from that described with reference to FIG. 1, in that it is also responsive to the output from a control loop 230. The control loop is responsive to the output +Vout, and in particular to the high side 111 of the output, and thus control loop 230 is shown in FIG. 2 as having an input connected to +Vout. In addition to controlling the control unit 210, control loop 230 also provides a control output to the bias circuit 220. The bias circuit 220 is effective to bias variable capacitor to C21, as will be described in more detail below. In addition, the bias unit 220 may be effective to bias the second capacitor C22, again in a fashion as will be described in more detail herebelow.

In this embodiment the second capacitor C22 is a second variable capacitor; however, in other embodiments the second capacitor may be a fixed capacitor C2.

The phrase “charge-pump capacitor array” is used throughout this application to include a single charge-pump capacitor, as well as a plurality of charge-pump capacitors. Thus the arrangement of FIG. 2 may be considered to comprise a buffer capacitor (C22) together with a charge-pump capacitor array having a single charge-pump capacitor (C21).

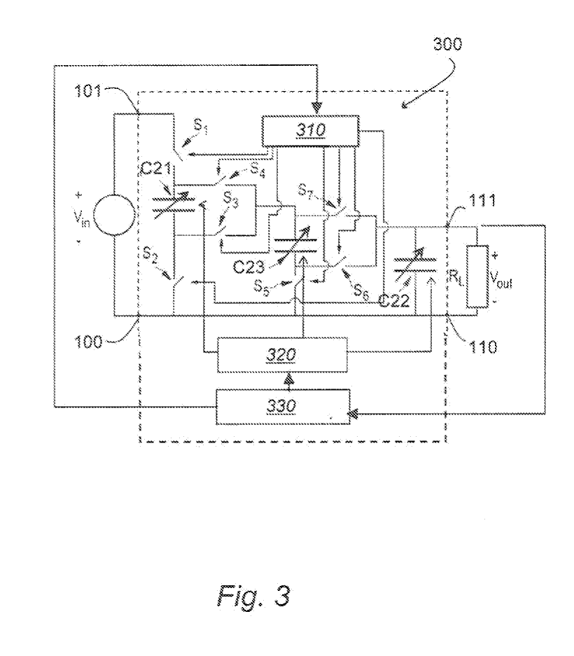

A second embodiment of the invention is illustrated in the schematic circuit diagram of FIG. 3. The layout of this embodiment is generically similar to that described above with reference to FIG. 2; however this embodiment differs from that shown in FIG. 2, in that this embodiment includes a further charge-pump capacitor C23. As a consequence, there are more control switches, and the bias circuit or bias control 320 controls two or three capacitors rather than one or two as in the previous embodiment.

The arrangement of the control switches differs in detail from that in the previous embodiments, in that, instead of connecting the high side 111 of the output to the first and second electrode of capacitor C1 respectively, switches S4 and S3 connect the respective electrode to the first electrode of further charge-pump variable capacitor C23. The second electrode of the further charge-pump variable capacitor C23 is connected to the common low sides 100 and 110 of input and output by via switch S5. The first and second electrode of further charge-pump variable capacitor C23 are connected to the high side 111 of the output via switches, S7 and S6 respectively.

In this embodiment, all of the charge-pump capacitors and the buffer capacitor are variable capacitors. However, it will be immediately apparent to the skilled person that the invention extends equally to the case where one or more of the capacitors are fixed capacitors, provided that at least one of the charge-pump capacitors is a variable capacitor.

The variable capacitor or variable capacitors used in a capacitive DC-DC converter according to the invention may be of any of several different types: the variable capacitors could be varactor diodes that are integrated on the same die as the control loop, current or voltage sensors and other electronics, e.g., in a CMOS or BiCMOS process. Alternatively, they could be ferroic capacitors. The term “ferroic” is used in this application in a broad sense, such as will be familiar to the skilled person. That is to say, the term is used to include materials that are not physically in either ferroelectric or antiferroelectric phase at operating conditions, but have a ferroelectric or anti-ferroelectric phase present elsewhere in the phase diagram. Furthermore, it is used to include all materials that have a voltage-dependent dielectric constant larger than 80, whether or not they are Ferroic stricto senso. It is known, for instance from U.S. Pat. No. 5,889,428, that Ferroelectric capacitors can be integrated with active electronics to replace the fixed capacitors; however, in embodiments of the present invention, they are used as tuneable, or variable, capacitors.

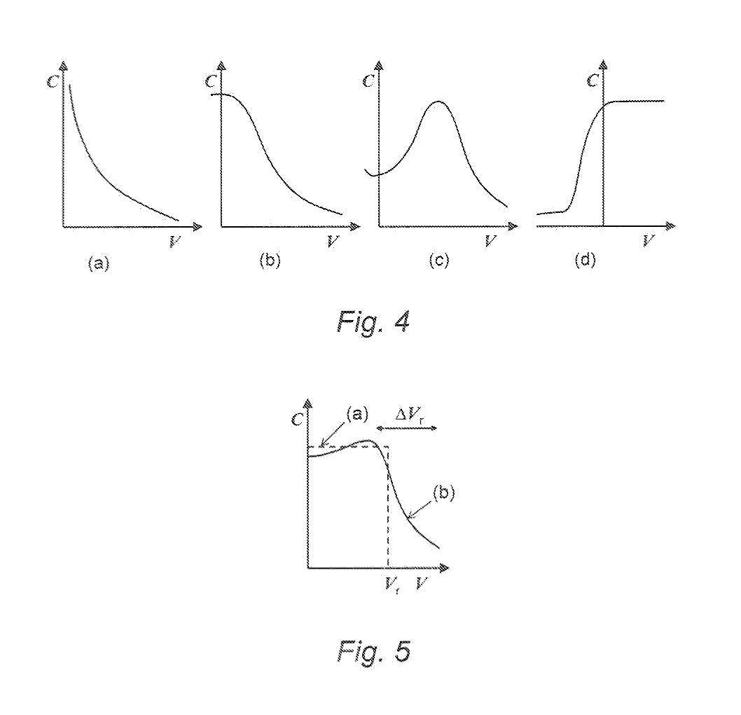

FIG. 4 shows example dependencies of the capacitance on the bias voltage, that is to say the C(V) response, for several variable capacitor technologies which may be used to advantage in embodiments of the present invention. FIG. 4 (a) shows a typical C(V) response of a varactor diode or a PIN diode. The capacitance has a sub-linear inverse relationship with the voltage. That is to say, the capacitance decreases with increasing voltage, but the rate of decrease of capacitance also decreases with increasing voltage. As the (positive) voltage tends towards zero, the capacitance tends towards a very high value, and the capacitance falls monotonically with increasing voltage, but does not fall to zero. FIG. 4(b) shows a typical C(V) response of a ferroelectric capacitor. The general response follows the same shape as that of a varactor diode; however, for a ferroelectric capacitor, the capacitance differs at low voltage in that it flattens out such that at zero voltage the capacitance is effectively flat. FIG. 4(c) shows a typical response for an anti-ferroelectric capacitor. At high voltages, the shape is the same as that of a ferroelectric capacitor: however, the response of this type of capacitor has a peak at a nonzero positive voltage: at small positive voltages the capacitance falls, but the rate of fall decreases with decreasing voltage, such that at zero voltage of the capacitance is nearly flat. Finally, at FIG. 4(d) is shown the C(V) response of a MOS varactor. Essentially, this has the response similar to a series connection of a varactor or (PIN) diode and a fixed capacitor. The capacitance has a small value for large and medium negative voltages; the capacitance rises steeply at small negative voltages and then flattens out to a constant, higher, a value for positive voltages.

As will now be discussed in more detail, some of these capacitor types may be used in embodiments of the invention without the requirement for an additional or separate control loop.

The voltage on the pump capacitor has a fixed ratio to the voltage on the load, dependent on the configuration switches. A change in the output voltage or the input voltage would thus change the capacitance directly. If the capacitance increases when the voltage on the capacitor decreases, then more charge is pumped into the load than would be the case for a fixed capacitor. The output voltage would be self-regulating for a very steep C(V) curve, such as that shown in dashed curve (a) of FIG. 5 which has a flat response at low positive bias and falls sharply to zero at a voltage Vr. There is no need for additional control circuitry: the capacitor already helps to stabilize output voltage.

In embodiments in which the variable capacitor possesses separate connections for a bias control voltage, as will be described in more detail below, then the bias voltage tap can be connected to the input or the output voltage. In the situation where the bias voltage tap is connected to the input voltage: if Vin increases, C decreases, resulting in higher output resistance of the converter: this leads to a decrease in Vout, counter-acting the increase due to Vin increase. Conversely, for the situation where the bias voltage tap is connected to the output voltage: if the output voltage increases, C decreases, so output impedance increases, leading to decrease in Vout, counter-acting the original increase.

In addition to the idealised response shown at dashed curve 5(a), FIG. 5 shows at curve 5(b) a good compromise C(V) curve for a partially self-regulating capacitor. The voltage dependence supports the regulation loop in the range of ΔVᵣ, that is to say, over the range of voltage where the capacitance is monotonically falling sharply with increasing voltage. Such a curve can be obtained in several ways: in particular, it can be obtained by optimizing the properties of either a ferroelectric or an anti-ferroelectric capacitor, or by combining a ferroelectric and an anti-ferroelectric capacitor, or by optimizing the doping profile of a semiconductor varactor diode or MOS varactor with well-controlled charges in the oxide layer.

In some applications it can be beneficial to be able to set the output voltage to an arbitrary value. The slope of the monotonically falling part, must, for these applications, therefore not become infinitely steep, but ideally span a voltage range that is determined by the switch array. By tailoring the capacitor response to have the largest steepness in the range where the voltage on the pump capacitor changes, one can gain a faster and more accurate regulation of the output voltage than with fixed capacitors. One option for this tailoring is to modify the doping profile of a varactor diode in a way which will be well-known to those skilled in the art. Another is to use ferroelectric or anti-ferroelectric materials or a combination thereof. By optimizing the material and the thickness of the dielectric layer, the coercive field and the C(V) response can be tailored to the application.

The embodiments described above include a bias circuit in order to control the bias on the variable capacitors. See, for instance, bias circuit 220 in FIG. 2, and bias circuit 320 in FIG. 3. The bias circuit provides for control of the pump capacitance independently of either the input or output voltage. It will be thus immediately apparent to the skilled person that the invention extends to embodiments where there is no bias circuit or bias control. In such embodiments the pump capacitance will be dependent on at least one of either the input or the output voltage. Such embodiments are thus less preferred since they offer a reduced level of independent control of the DC-DC converter. However, for some applications they may be advantageous since they require fewer components and simplified control.

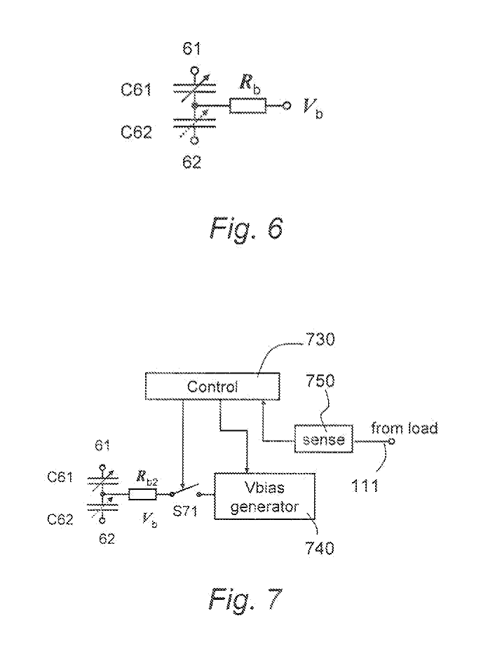

Since it is advantageous to embodiments of the invention that the average DC voltage on the pump capacitor (or pump capacitors) can change, from one viewpoint there is always a bias voltage on the capacitor. In the simplest case of a 2-terminal variable or tuneable capacitor, the bias is provided simply by the voltage across the capacitor. However, in preferred embodiments a more sophisticated method of biasing the tuneable capacitor is adopted. This is illustrated in FIG. 6. FIG. 6 shows a variable capacitor C61. Connected in series with the variable capacitor C61 is a second capacitor C62. This second capacitor C62 may be either a fixed DC blocking capacitor or another variable capacitor. The first electrode of variable capacitor C61 is connected to terminal 61, the second electrode of C61 is connected to a first electrode of second capacitor C62 and to a common node, and the second electrode of second capacitor C62 is connected to terminal 62. Also connected to the common node, is the bias resistor Rb which is in turn connected to a bias voltage Vb.

The variable capacitors shown in the previous embodiments as single capacitor, such as C21, are replaced according to this biasing scheme, by the pair of capacitors C61 and C62. So for example in the embodiment shown in FIG. 3, the terminals 61 and 62 are connected to switches S1 and S2 respectively.

Introduction of the second capacitor C62, and the biasing resistor Rb, introduces losses, which vary roughly with 1/(ω.Rb.C61), hence a large value for the biasing resistor Rb is preferred. However, this results in a long time constant for varying the bias, which time constant scales according to Rb.(C61+C62). Thus provision of low-loss biasing can result in a slow response of the bias circuit. To mitigate against this, a bias circuit such as that shown in FIG. 7, which is integrated with the control loop, is employed in embodiments of the invention.

FIG. 7 shows the bias circuit of FIG. 6 modified in that the bias terminal is switchably connected, by means of switch S71, to bias voltage generator 740. Both the bias voltage generator 740 and the switch S71 are under the control of the control loop 730. The control loop, 730 senses the load voltage at the high side 111 of the output by means of a sensor 750. Sensor 750 may be a simple voltage tap. If the output voltage (or the output current, in the case where current is used as the primary control) deviates too much from the desired value, e.g. after a fast transient of the load resistance, the control loop can close S71 and quickly adapt the value of the pump capacitor combination C61/C62 to the required value for maintaining the wanted output voltage or current.

In operation, the pump capacitor is connected periodically to various voltage levels, for instance the output voltage and the supply voltage, as is described above for instance with reference to FIG. 2. The capacitance value is controlled by the voltage between the terminals of the capacitor itself. Since in a typical configuration, the time constant for charging the pump capacitor by the bias resistor is larger than the period of the switching cycle, the bias voltage is applied relative to an averaged voltage at the terminals 61 and 62 of the pump capacitors. In embodiments, the controller is configured to take this into account; however, as a non-limiting alternative in other embodiments, the application of the bias voltage is simply and conveniently synchronised with the switching cycle, by means of by switch S71. In these embodiments the bias voltage is only applied when the pump capacitor is connected to a well known, or clearly defined, potential, such as when terminals 61 or 62 are connected to either ground or the supply voltage. In these embodiments, also the required control voltage range of the bias generator can be chosen more freely, depending in which part of the cycle the bias is applied.

Since the bias circuits shown in FIG. 6 and FIG. 7 are able to control the voltage across the charge-pump variable capacitor, they can also be used to regulate the maximum input current which is drawn by the converter. In turn, this can be used to either limit losses or to set the charging speed of the converter. Thus, without additional circuitry, advantageously, improved regulation or protection of the circuit is provided by embodiments of the invention which utilise such bias circuits.

Since capacitive DC-DC converters in accordance to the invention are not dependent on bulky magnetic or other inductive elements, embodiments of the invention are particularly suited, without limitation, to integration in small or miniaturised devices. As discussed above, the variable capacitors may, in embodiments, be varactor diodes or MOS varactors, which are particularly suited to being, and may be, integrated on the same die as a control loop, current or voltage sensors, or other electronics. Further, ferroelectric capacitors can be integrated with active electronics to replace the fixed capacitors on the same die. The terms “die” and “substrate” will be used interchangeably herein.

For specific applications, it can nevertheless be more attractive to use a dedicated substrate to allow for specific material optimization, e.g., high temperatures and lower manufacturing costs. System-in-package technologies allow combining the two substrates for the active (switches, control) and passive elements, and the invention extends to capacitive DC-DC converters manufactured according to the system-in-package technologies.

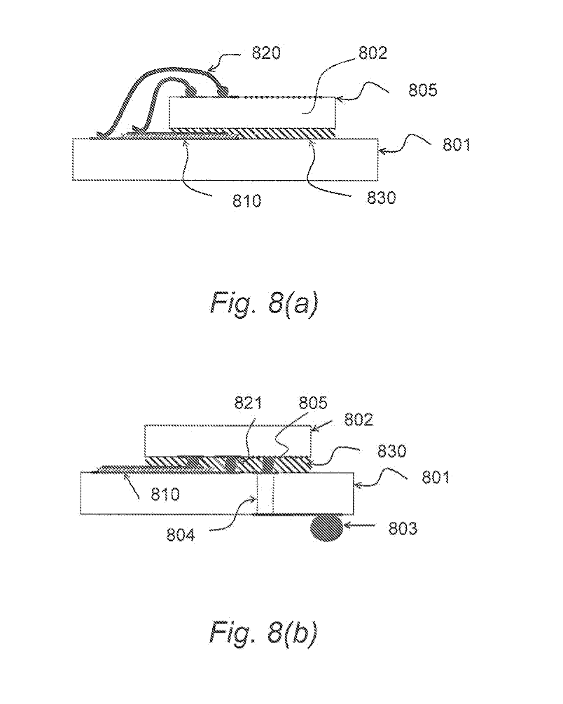

Non-limiting examples of such technologies which are particularly suited to embodiments of the invention which utilise ferroelectric or anti-ferroelectric variable capacitors as charge-pump capacitors are shown in FIGS. 8(a) and 8(b). Substrate 801 contains the pump capacitors 810, plus other possible components that are not easily integrated in the logic circuitry, such as electrostatic discharge (ESD) protection or high-quality resistors. The capacitor 810 may be, without limitation, a ferroelectric capacitor or a varactor diode, in a planar form or in trenches. Second, conventional, substrate 802 is attached to the first substrate 801 by means of glue or underfill 830. The electrical connection between the first substrate 801 and the second substrate 802 is provided in FIG. 8(a) by means of wire bonds 820, and in FIG. 8(b) by means of bump bonds 821. The substrate 801 may be double-sided and include vias 804, and/or bump connections 803.

Seen from an alternative viewpoint, by application of Thevenin's theorem, the above embodiments can be seen as capable of controlling the output current, rather than the output voltage directly: in order to control the output current Iout for a specific given value of output voltage of Vout, appropriate values of M and Rcp need to be chosen (where M is the voltage multiplier of the converter such that Vout=M*Vin, and Rcp is the output impedance of the capacitive converter). In effect, whether the control is viewed as controlling Vout directly or controlling Iout at a certain externally imposed Vout), the impedance of the convertor is changed by varying the pump capacitors.

Thus it will be apparent from reading the present disclosure that a charge-pump capacitive DC-DC converter is disclosed, which includes a reconfigurable charge-pump capacitor array. The DC-DC converter is configured to provide a continuously variable ratio between its input voltage and its output voltage, by means of at least one of the at least one charge-pump capacitors forming the reconfigurable array being a variable capacitor. In the embodiments, the one or more variable capacitors may be a ferroelectric capacitor, an anti-ferroelectric capacitor, or other ferrioc capacitor. The DC-DC converter may provide a bias circuit to the capacitor or capacitors, and may further provide a control loop. Alternatively, the capacitor may provide a degree of self-control.

From reading the present disclosure, other variations and modifications will be apparent to the skilled person. Such variations and modifications may involve equivalent and other features which are already known in the art of DC-DC converters and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A capacitive DC-DC converter comprising
an input for receiving current at an input voltage,
an output for supplying current at an output voltage,
a charge-pump capacitor array which is reconfigurable within the DC-DC converter and comprises at least one charge-pump capacitor,
a plurality of switches for reconfiguring the reconfigurable charge-pump capacitor array,
wherein
the capacitive DC-DC converter is configured to provide a continuously variable ratio between the input voltage and the output voltage with at least one of the at least one charge-pump capacitors being a variable capacitor,
the capacitive DC-DC converter further comprising a bias circuit for biasing the variable capacitor, the bias circuit comprising a further capacitor in series with the variable capacitor, and the node therebetween being connected to a bias voltage a bias resistor.

2. A capacitive DC-DC converter as claimed in claim 1, wherein the variable capacitor is adapted such that its capacitance decreases as a voltage across it increases, over a predetermined voltage range.

3. (canceled)

4. (canceled)

5. A capacitive DC-DC converter as claimed in claim 1, further comprising a control loop for controlling the variable capacitor.

6. A capacitive DC-DC converter as claimed in claim 5, wherein the control loops includes sensing means for sensing the output voltage and control means for controlling the biasing circuit.

7. A capacitive DC-DC converter as claimed in claim 5, configured such that the output voltage is independent of variation in the input voltage, and its either variable or constant.

8. (canceled)

9. A capacitive DC-DC converter as claimed in any preceding claim, wherein the charge-pump capacitor array comprises a plurality of charge-pump capacitors.

10. A capacitive DC-DC converter as claimed in claim 1, further comprising a buffer capacitor connected across the output.

11. A capacitive DC-DC converter as claimed in claim 1, wherein the at least one charge-pump capacitor and the plurality of switches are provided on the same substrate.

12. A capacitive DC-DC converter as claimed in claim 11, wherein the at least one charge-pump capacitor is a semiconductor varactor.

13. A capacitive DC-DC converter as claimed in claim 1, wherein the at least one charge-pump capacitor and the plurality of switches are provided on separate substrates and are integrated into the same package.

14. A capacitive DC-DC converter as claimed in claim 13, wherein the at least one charge-pump capacitor is a ferroic capacitor.

15. A method of controlling a capacitive DC-DC converter comprising an input for receiving an input voltage, an output for supplying an output voltage, a reconfigurable charge-pump capacitor array comprising at least one charge-pump variable capacitor and a plurality of switches for reconfiguring the reconfigurable charge-pump capacitor array,
the method comprising varying at least one of the at least one charge-pump variable capacitor such that the output voltage is controlled independent of variation in the input voltage,
the method including the step of biasing at least one of the least one variable capacitor, with a bias circuit comprising a further capacitor in series with the variable capacitor, the node therebetween being connected to a bias voltage with a bias resistor.

16. (canceled)

17. The method of claim 15, including the step of sensing the output voltage and biasing at least one of the at least one variable capacitor in dependence on the output voltage.

18. The method of any of claim 15, wherein the step of biasing at least one of the at least one variable capacitor further involves regulating a maximum input current drawn by the capacitive DC-DC converter.

19. The method claim 15, wherein the capacitive DC-DC converter operates according to a pump cycle and the at least one of the at least one variable capacitor is biased synchronously with the pump cycle.
